(19) United States
(12) Patent Application Publication
(10) Pub. No.: US 2026/0312872 A1
(43) Pub. Date: Oct. 8, 2026

(54) LOCATION DETERMINATION BASED ON NETWORK ELEMENT CLUSTERING

(71) Applicant: HEWLETT PACKARD ENTERPRISE DEVELOPMENT LP, Spring, TX (US)

(72) Inventors: VIKRAM RAGHU, Santa Clara, CA (US); ELDAD PERAHIA, Park City, UT (US); DENIS HOULE, St. Laurent,, CA (US)

(21) Appl. No.: 19/172,122

(22) Filed: Apr. 7, 2025

(51) Int. Cl. H04L 41/0893; H04L 41/12

(52) U.S. Cl. CPC H04L 41/0893; H04L 41/12

(57) ABSTRACT

Systems and methods are provided for refining the determination of clusters of network elements in a deployment to account for weakly linked network elements. Relative distances between network elements can be determined and represented in a matrix to which two different clustering algorithms are applied. A first one of the clustering algorithms determines a first set of clusters of network elements, while a second one of the clustering algorithms refines the first set of clusters of network elements until all the determined clusters of network elements are isolated clusters of network elements.

### CROSS-REFERENCE TO RELATED APPLICATIONS

The present application is related to co-owned U.S. Pat. No. 11,917,575, issued Feb. 27, 2024, which is a continuation of U.S. Pat. No. 11,229,000, issued Jan. 18, 2022, both of which are incorporated herein by reference in their entirety.

### BACKGROUND

The deployment of access points (APs), especially in large facilities, can involve placing/installing APs in a variety of locations, e.g., in ceilings, behind walls, hidden within or proximate to structures, etc. Moreover, an AP deployment can comprise APs that are placed on multiple floors of a building, different areas of a floor, e.g., wings, hallways, rooms, and so on.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1A illustrates an example of an access point (AP) deployment in a facility with distinct AP clusters.

FIG. 1B illustrates an example of an AP deployment in a facility with linked AP clusters.

FIG. 2 illustrates adjacency matrices representative of the AP deployments of FIGS. 1A and 1B.

FIG. 3A is a flow chart illustrating example operations performed to identify distinct/separate AP clusters in a deployment in accordance with examples of the disclosed technology.

FIG. 3B illustrates an example adjacency matrix and clusters determined in accordance with examples of the disclosed technology.

FIG. 4 depicts an example computing component that may be used to effectuate a constrained, recursive algorithm for determining the location of APs in a deployment in accordance with examples of the disclosed technology.

FIG. 5 is a computing component that may be used to implement examples of the disclosed technology.

The figures are not exhaustive and do not limit the present disclosure to the precise form disclosed.

### DETAILED DESCRIPTION

As described above, the deployment of APs in a facility can result in those APs being installed in various areas of the facility. Once the APs are installed, there may be a need to later determine the location of those APs. For example, there may be a desire to service an AP, replace an AP, or modify the placement of the AP to facilitate a better connection to user devices. The location of APs in a deployment may be determined with the use of a map, if such a map exists.

Thus, examples of the disclosed technology are directed to an application or tool capable of automatically determining or mapping the locations of a set of APs within a deployment. With the implementation of Fine Timing Measurement (FTM), an 802.11 protocol, wireless devices can calculate the distance between each other (relative distance) to a high degree of accuracy. The application can leverage FTM while using a technique known as Multi-dimensional Scaling (MDS), a machine learning (ML) dimensionality reduction technique. MDS can be used to determine the location of APs from proximity data (i.e., the relative distances between APs). More particularly, MDS may be applied to generate a set of locations representing the relative positions of a number of objects, e.g., APs, based upon a table of the distances between them. The set of locations may be in any number of dimensions, and more specifically, in terms of AP mapping in a facility, may provide both 2D and 3D mapping based on a proximity table or matrix describing the distances between each pair of APs. Stated mathematically, MDS may be applied to translate information about pairwise distances among a set of n objects (e.g., APs) into a configuration of n points (AP locations) mapped into Cartesian space.

In some scenarios such as multi-floor buildings or large area deployments with clusters of APs in different areas or oddly shaped buildings with two or more main areas separated by hallways, it is beneficial to divide the floorplan into subsections and handle each section individually. In other words, it can be beneficial to determine the location of APs on a cluster-by-cluster basis rather than attempting to determine the location of all APs in a deployment at once, e.g., determining the location of APs can be performed on a per-section/per-area basis of a facility.

However, relying on a user/customer to define these AP clusters can introduce complexity and lower the reliability of the application. Accordingly, examples of the disclosed technology are further directed to automatically identifying sets or clusters of APs belonging to different areas or sections of a deployment. It should be noted that automated cluster determination can produce other benefits, such as detecting errors in customer AP deployment or labelling, and can also serve to further heighten the accuracy of other location determining methods, such as sensor-based or Global Positioning System (GPS)-based methods.

In order to be able to identify clusters of APs, the input proximity matrices used to determine relative distances between APs are converted into adjacency matrices that represent valid network links with a value of 1, and missing network links with a value of 0. For clustering involving adjacency matrices as inputs, spectral clustering techniques tend to work best. A popular/appropriate spectral clustering technique is Louvain's algorithm. Louvian's algorithm requires an adjacency matrix as its input, as well as a resolution parameter or value that defines the strictness of what constitutes a cluster. To have a strict definition of a cluster, the ratio of 1s to 0s in an adjacency matrix should be large. However, the resolution parameter varies depending on the size of the adjacency matrix, negating the effectiveness of Louvain's algorithm.

Thus, to work around the varying resolution parameter issue, examples of the disclosed technology apply a disjoint set function to an adjacency matrix. The disjoint set function can be used to isolate sets (clusters) of APs in a deployment represented in the adjacency matrix. The disjoint set function can be thought of as a strict clustering method. After applying the disjoint set function, Louvain's algorithm (using an optimal resolution parameter determined through testing) can be run on a cluster(s) that are output/represented by adjacency matrix disjoint set(s). If running Louvain's algorithm results in a single cluster of APs, that AP cluster can be returned as a “final” output. However, if a single/isolated cluster of APs has not been determined by Louvain's algorithm, the clusters can be divided into smaller and smaller clusters using Louvain's algorithm until a cluster can no longer be divided, and only a single/isolated cluster remains.

Once isolated AP clusters have been determined, the adjacency matrices can be turned back into proximity matrices that can be used by MDS to determine the locations of the APs in those clusters.

As used herein, the term AP (also referred to as a wireless access point (WAP)) refers to a networking hardware device that allows devices to connect to a wired network, including connection to the Internet or an intranet. The AP may connect to a router (via a wired network) as a standalone device or may be an integral component of the router itself. An AP may include, but is not limited to, a Wi-Fi AP operating under operating under one or more IEEE (Institute of Electrical and Electronics Engineers) 802.11 standards. An AP may also operate using any other wireless communication technology, including, for example, cellular communications (including 4G and 5G technology), Bluetooth, ZigBee, and other technologies. It should be noted that while examples of the disclosed technology are described in the context of mapping the location of APs, any network element whose location can be determined using FTM (or other mechanism(s) for determining relative distance) may be mapped.

Solutions to technical problems rooted in computer technology are provided in accordance with examples of the disclosed technology. As noted above, difficulties can arise when attempting to determine the location of network elements, such as APs, due to complex installations or deployments. Such difficulties are only exacerbated when installations or deployments are not only complex, but also large in scale. Examples of the disclosed technology can be implemented as an application or tool that a user or customer may wish to use at any time. The use of algorithms to optimize the identification of clusters on which location determinations can be based could not be performed without the use of computerized technologies such as those described herein, or the practicality and on-demand usage of the disclosed technology would be lost/impossible. As can be appreciated from the description of the disclosed technology herein, given the derivation and manipulation of matrices, and the computations performed attempts at “manual” implementation would likely result in errors, not to mention undesirable delays. Thus, examples of the disclosed technology, by being rooted in computer technology, avoid the introduction of human/mental errors or oversights, and can provide real-time or near real-time results.

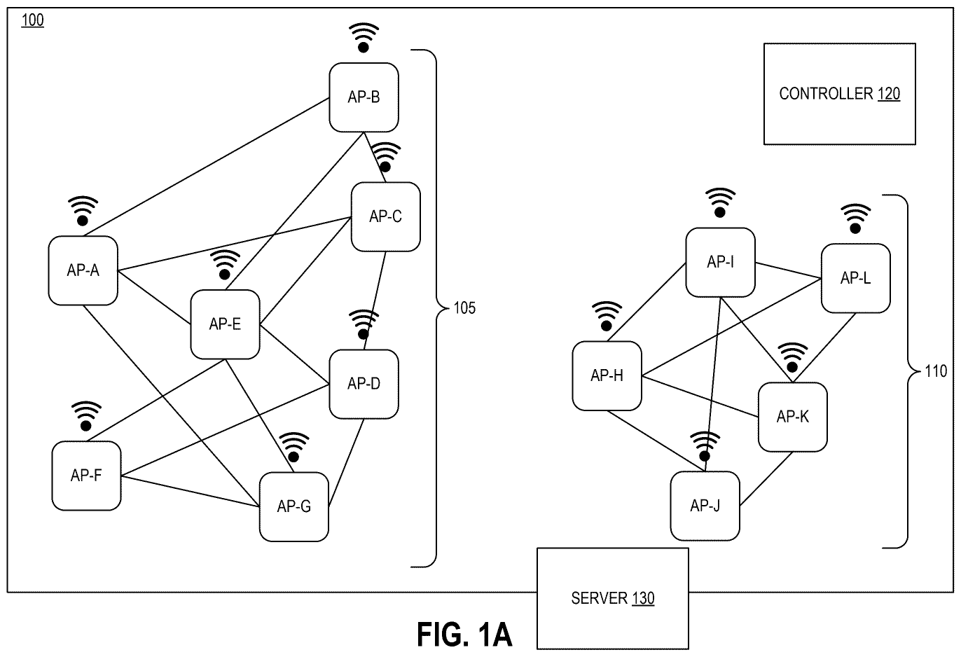

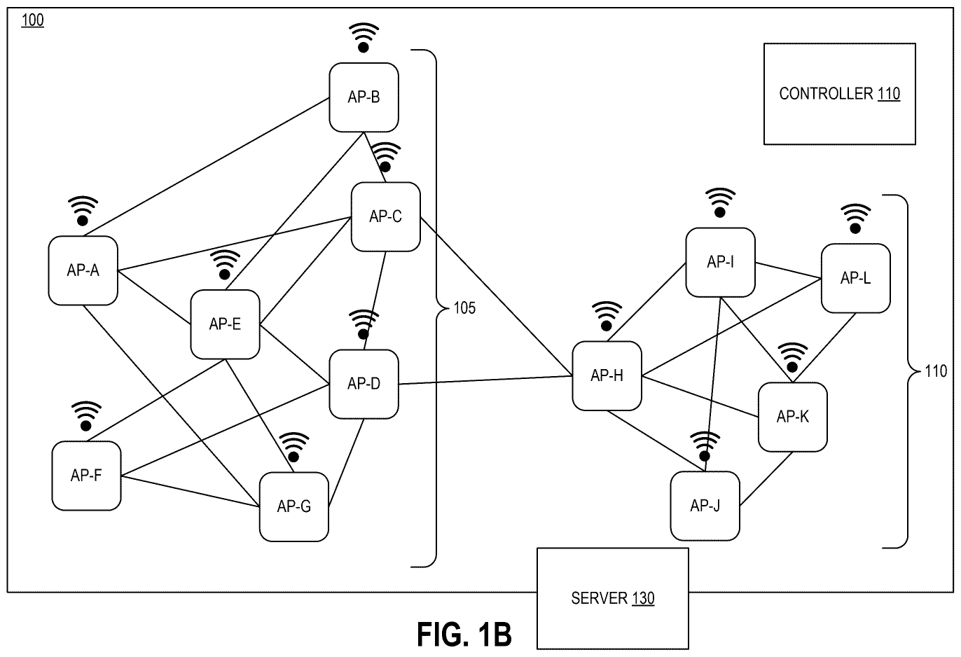

FIG. 1A is an illustration of a facility 100 including multiple APs in a network. As illustrated in FIG. 1A, a particular facility 100 may have a large number of access points that are scattered throughout the environment to provide wireless communication coverage. This particular example illustrates a set of twelve APs designated as AP-A through AP-L, but any number may be present within a facility or deployment. In some examples, the network may include a central controller 120 to control certain operations of APs AP-A to AP-L. A server (or other computing device) 130 can be used to determine the location of APs (such as APs AP-A to AP-L) using MDS.

As illustrated in FIG. 1A, APs AP-A to AP-G are deployed in such a way that they may comprise a cluster 105. It can be appreciated that cluster 105 is separate and distinct from APs AP-H to AP-L, which may comprise a cluster 110. In this example, when determining the location of APs AP-A to AP-L, the location of the APs comprising cluster 105 can be determined separately from the location of the APs comprising cluster 110. From an algorithmic standpoint, when presented with the relative distances of APs AP-A to AP-L to one another, a disjoint set function can readily isolate clusters 105 and 110 from one another, and the locations of their respective APs can be determined by server 130 using MDS.

However, when clusters are not so easily distinguished or isolated, determining the location of APs cannot be addressed through the use of a disjoint set function alone. Consider the deployment illustrated in FIG. 1B. Similar to the deployment illustrated in FIG. 1A, facility 100 may have a large number of APs that are scattered throughout the environment to provide wireless communication coverage (i.e., APs AP-A through AP-L). In some examples, the network may include a central controller 120 to control certain operations of APs AP-A to AP-L. A server (or other computing device) 130 can be used to determine the location of APs (such as APs AP-A to AP-L) using MDS. Unlike the example of FIG. 1A, though, APs AP-C, AP-D, and AP-H are linked, albeit weakly. For example, the transmissions of AP-C, AP-D, and AP-H may be heard or picked up by one another, suggesting some physical proximity to one another. Visually, it can be appreciated that clusters 105 and 110 are more-or-less distinct from one another, and while, operationally, this may not pose an issue, from a mapping perspective, these links prohibit simple algorithmic isolation of clusters 105 and 110. That is, a proximity matrix representative of this deployment only provides relative/pair-wise distances between APs AP-A to AP-L with a value of “0” indicating there is no “link” between two or more APs. Thus, the use of conventional clustering methods, such as the application of a disjoint set function alone, would treat this deployment as one cluster, which is not ideal for accuracy.

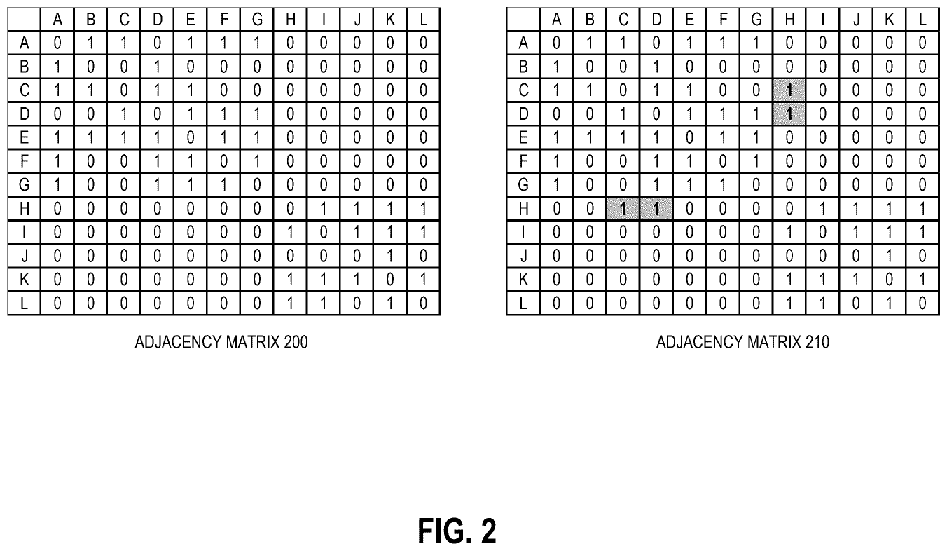

FIG. 2 illustrates a comparison between adjacency matrices 200 and 210 representative of the deployment of APs of FIG. 1A and FIG. 1B, respectively. As noted above, examples of the disclosed technology implement a clustering algorithm. Due to the form of an input based on FTM being proximity matrices (at times with missing distance data), algorithms that rely on using a mean distance to cluster centers are unusable. Some methods may attempt to artificially fill in or populate missing distance data with a value. However, this can introduce errors when dealing with AP deployments of differing densities as threshold density values used as bases for clustering may change amongst areas of a facility.

Against this backdrop, proximity matrices reflecting relative distances between APs are converted into adjacency matrices. To perform such a conversion, entries in a proximity matrix with a non-zero value are converted to a “1” in the adjacency matrix, and entries in the proximity matrix with a zero or missing value are converted to a “0” in the adjacency matrix. The result is an adjacency matrix that depicts valid links in a deployment/network of APs as “1” and missing links/non-existent links as “0.” Referring to FIG. 2, it can be appreciated that adjacency matrix 210 (representative of the example of FIG. 1B) reflects values of “1” for the links between APs AP-C, AP-D, and AP-H. This is in contrast to adjacency matrix 200 (representative of the example of FIG. 1A) that reflects values of “0” between APs AP-C, AP-D, and AP-H. Again, this is because there is no link between those APs in the example of FIG. 1A. Thus, the example of FIG. 1B is representative of a scenario in which examples of the disclosed technology can be used to define or determine clusters of APs, where the conventional of a disjoint set function alone would be ineffective to accurately identify distinct AP clusters 105 and 110. As noted above, spectral clustering, and more particularly, Louvain's algorithm can be used to maximize the ratio of all links (between APs) within a cluster to the number of links between nodes of that cluster and any other cluster.

In addition to the adjacency matrix, a resolution parameter can be derived as a way to increase the strictness of which constitutes a cluster. However, as discussed above, a resolution parameter that is optimally tuned or set to a value that results in an adjacency matrix with a large ratio of 1s to 0s (reflecting strict clustering), cannot be universally applied to datasets of differing sizes. That is, the optimal resolution parameter for a dense cluster cannot be the same/similar for a more sparse cluster. This makes using Louvain's algorithm exclusively to determine clusters, unfeasible for different deployments that have different densities. In other words, a “universal” solution reliant on Louvain's algorithm alone, would not result in the accurate determination of clusters.

Moreover, as will be described in greater detail below, while FTM can be used to derive distance data between APs, the rotation of inversion of AP locations in 3D (or 2D) space cannot be resolved without the use of anchor point APs. That is, installation of an AP may result in that AP being oriented in various directions at a particular location, or even inverted, and to resolve mapping of a proximity matrix in 3D/2D space, the location of at least three anchor points is desired. In order to reduce the number of anchor point APs needed for resolution of a proximity matrix, the resolution parameter should be set to a low value.

Accordingly, to avoid the issues related to defining an optimal resolution parameter, a constrained, but recursive clustering algorithm is used in accordance with examples of the disclosed technology. It should be understood that Louvain's algorithm operates with a defined resolution parameter that is as optimal as possible (derived, e.g., through testing). However, the limitations associated with conventional use of Louvain's algorithm along with the resolution parameter can be overcome through the use of recursive clustering as disclosed herein.

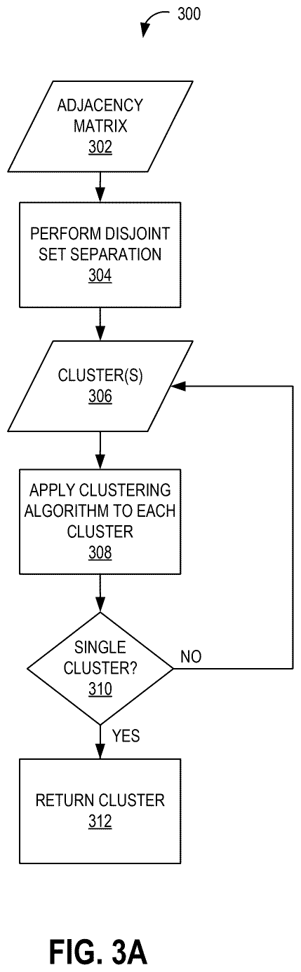

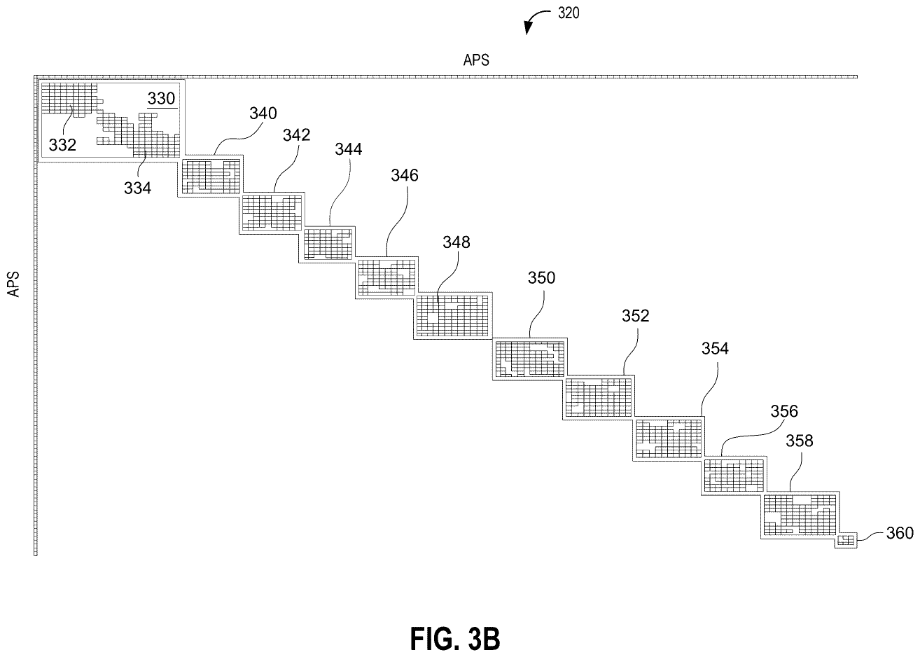

FIG. 3A illustrates operations performed by such a recursive clustering algorithm 300. At operation 302, an adjacency matrix is established or derived from a proximity matrix. That is, APs can be instructed, e.g., by server 130 or controller 120 (FIG. 1) to determine a distance between each pair of APs. The APs may, for example, determine the distances using AP signaling, such as using measurement of time of flight of signals between the APs to determine the distance between each pair of APs. The distance determination may include the use of FTM between each pair of APs. FTM is a feature provided in IEEE 802.11mc for determining distances between stations utilizing time of flight of frame exchange between a sending station and a receiving station. FTM may be utilized to provide accurate measurement of distances based on direct signal transmissions (i.e., line-of-sight in terms of signal transmission) between each pair of APs in a facility. More particularly, APs may exchange signals with timestamps, and the APs can calculate round-trip times (RTTs) of those exchanged signals, which can then be used to estimate distances between APs that have exchanged signals.

The result of the distance measurement process between each pair of APs is a set of data describing distances between all APs in the facility. In some examples, a table may be generated to represent the set of data (not illustrated). The table may be referred to as a distance matrix or proximity matrix. A proximity matrix is a representation, such as in the form of a two-dimensional array, of pairwise distances between the elements of a set, which in this case is the set of APs AP-A through AP-L. The distance measurement for each pair of APs may be received by server 130, which then generates a proximity matrix based on the received data measurements.

It should be noted that any signaling/signal reading between two networks devices, such as APs, can be used as a basis for distance determination. For example, signals reflecting strength, e.g., Return Signal Strength Indication (RSSI), or other signals that can typically be exchanged between network devices, such as beacons, Bluetooth transmissions, Ultra-Wideband (UWB) readings, etc. can reflect what network devices may be closer/farther to one another (stronger signals equating to being closer) or which network devices are neighbors to one another. Such signaling information can be converted or translated into an adjacency matrix (no intermediate proximity matrix being needed). For example, receipt of such a signal at a network device suggests that the network device is a neighboring device (reflected as “1” in an adjacency matrix), while not receiving a signal suggests the pair of network devices under consideration are not neighbors (reflected as “0” in an adjacency matrix).

Once a proximity matrix has been derived or established, the proximity matrix may be converted into an adjacency matrix. An adjacency matrix refers to a matrix that represents how vertices in a graph are connected, where the elements/values of the adjacency matrix indicate whether pairs of vertices (in this case, pairs of nodes/APs) are adjacent to one another To perform such a conversion, entries in a proximity matrix with a non-zero value are converted to a “1” in the adjacency matrix, and entries in the proximity matrix with a zero or missing value are converted to a “0” in the adjacency matrix. Because the existence of a non-zero value in the proximity matrix evidences a distance between two nodes/APs, the presence of a “1” in the resulting adjacency matrix indicates that the two nodes/APs are adjacent or linked. In the disclosed technology, being linked or adjacent to one another suggests that the pair of nodes/APs should possibly belong to the same cluster of nodes/APs. In contrast, the presence of a “0” in the adjacency matrix indicates that the nodes/APs are not adjacent or linked to one another, and thus, should not be in the same cluster of nodes/APs.

At operation 304, disjoint set separation (a method that can be used to identify clusters) is performed on the adjacency matrix derived at operation 302. In set theory, disjoint sets are sets that have no elements in common, in other words, disparate clusters. To determine the existence of disjoint sets, a check is performed to determine if two elements belong to the same set or not by finding the representative (parent) of each of the two elements. If the representative of the two elements is the same, they belong to the same set. This check can be repeated for all elements of interest, until disjoint sets (if they exist) are identified. In the context of an adjacency matrix, disjoint set separation can be performed by traversing the adjacency matrix to determine the representative of each of the indexes (intersection of two nodes/APs) of the adjacency matrix. It should be understood that some indices, by default will reflect a 0 because the distance of a node/AP relative to itself is zero. See, e.g., adjacency matrices 200 and 210 of FIG. 2, where the main diagonals (also referred to as leading or principal diagonals) comprise distances “between” node A and itself, node B and itself, etc. More particularly, if the value at an index is “1,” its neighbors are checked to determine if a neighbor index value is also “1.” If so, a union of the index and its neighbor is taken. This traversal, checking, and performing unions (when warranted) for neighbors can be repeated for all the indices until all disjoint sets in the adjacency matrix have been identified.

The result of performing disjoint set separation at operation 304, are the determination or identification of one or more clusters at operation 306. As discussed above, the identification of clusters using disjoint set separation can result in strict definitions of clusters. Practically speaking, this means that two or more clusters that are only weakly linked, still may be identified as a single cluster. However, as also discussed above, when attempting to map or determine the location of APs on a cluster-by-cluster basis, the determination can be skewed/lead to inaccuracies when the clusters include weakly linked APs.

Accordingly, at operation 308, another clustering algorithm is applied to each cluster that was determined/identified at operation 306. As noted above, the use of a disjoint set function can identify an initial cluster or set of clusters that can be further refined using Louvain's algorithm (an example of a clustering algorithm). Louvain's algorithm is based on the idea of optimizing a measure referred to as “modularity.” Modularity quantifies the quality of a “community structure” (in this context, a cluster) by comparing the number of edges (links between nodes/AP) within communities to the expected number of edges if the network of nodes were randomly connected. Ultimately, Louvain's algorithm seeks to maximize a modularity score of a community structure/cluster, which indicates a strong community structure. In this context, a strong community structure is analogous to an accurately determined cluster, e.g., a cluster without any weak links between nodes/APs that, as discussed above, could negatively skew clustering determinations.

The application of Louvain's algorithm involves iterating through the indices of an identified cluster, and assigning an index to its own community/cluster. Louvain's algorithm can then iterate through the indices to evaluate the modularity gain by moving each index to its neighboring communities/clusters, and calculate the change in modularity that would result from such a move. After all nodes/APs are evaluated, Louvain's algorithm aggregates the nodes/APs into their newly determined communities/clusters. The iterative improvement and community/cluster aggregation operations can be repeated until no further improvement in modularity can be achieved. At this point, Louvain's algorithm can output a final community structure (cluster) where nodes/APs within the same community/cluster are more densely connected to one another than to nodes/APs belonging to another community/cluster.

At operation 310, a check is performed to determine whether the result of applying the clustering algorithm at operation 308 results in the identification of a single cluster. If not, constrained recursive algorithm 300 returns to operation 306, where the clustering algorithm is applied again until the result obtained is a single cluster at operation 310.

Once a single cluster has been identified, a matrix representative of a single cluster is returned at operation 312. In other words, an adjacency matrix comprising distinct/separate clusters is output.

Once a cluster is returned, the adjacency matrix representing the cluster can be converted back into a proximity matrix. The proximity matrix data does not in itself describe the physical locations of the APs that are represented in the proximity matrix. In some examples, the proximity matrix is solved to determine a location of each AP in relation to each of the other APs. In some examples, the determined locations may be used in generating a map of the APs.

FIG. 3B illustrates an example scenario where clusters within an adjacency matrix are determined in accordance with examples of the disclosed technology. FIG. 3B may represent an example adjacency matrix 320, such as adjacency matrices 200 and 210 illustrated in FIG. 2, but comprising a much larger number of APs, and resulting indices. Like adjacency matrices 200 and 210, the existence of a 1 at an index (here, represented as a box/point) suggests that APs are adjacent/linked. Examples of such indices are indices 322, 324, 326, and 328. The lack of a point/box in adjacency matrix 320 suggests that no link between the node(s)/AP(s) of an index. It should be understood that individual “1's” and “0's” are not illustrated, nor are all indices labeled for legibility due to the scale of adjacency matrix 320.

Consider, for example, that adjacency matrix 320 is representative of an AP deployment or network in a building with 12 floors, the lowest floor being split across two buildings. As described above, the APs of the deployment may be instructed to determine a distance between each pair of APs via, e.g., AP signaling, such as using measurements of time of flight of signals between the APs to determine the distance between each pair of APs. These distances can be used to generate a proximity matrix, where the distances between two APs (or relative to an AP itself) are represented as indices of the proximity matrix. This proximity matrix can be converted into an adjacency matrix by replacing indices with a distance value with “1's,” and by replacing indices with no associated distance value with “0's.”

As also described above, with respect to FIG. 3A, disjoint set separation can be performed on an adjacency matrix, such as adjacency matrix 320. It should be understood that adjacency matrix 320 may be an up-scaled example of adjacency matrices 200/210 of FIG. 2. Again, the scale of deployments where the location of APs may be determined in accordance with examples of the disclosed technology can be very large. A first set of clusters may result from the performance of disjoint set separation. In the example scenario of FIG. 3B, the application of disjoint set separation may result in the determination of 11 clusters of APs (clusters 340-360) amongst the first 11 floors of the building represented by adjacency matrix 320. It can be appreciated, visually, that the density of APs comprising AP clusters 340-360 is such that these clusters can be treated as stand-alone clusters that cannot be further broken down into more clusters.

The application of disjoint set separation with respect to floor 12 (which as noted above, is split between two buildings) identifies a cluster 330. However, and consistent with the deployment of APs in cluster 330 spanning two buildings, a first set/cluster of APs 332 (in a first building of the two buildings) may only be weakly linked to a second set/cluster of APs 334 (in a second building of the two buildings).

Visually, it can be appreciated that AP clusters 332 and 334 should be handled separately when determining the locations of the APs making up AP clusters 332 and 334. Accordingly, by applying Louvain's algorithm to cluster 330, it will be determined that cluster 330 can be further segmented into smaller clusters, i.e., AP clusters 332 and 334.

Solving a proximity matrix with a large number of values is computationally difficult. In some examples of the disclosed technology, determining the location of APs from the proximity (matrix) data is performed utilizing MDS. MDS may be applied to generate a set of locations representing the relative positions of a number of objects (in this case, APs) based upon a table of the distances between them. The set of locations may be in any number of dimensions, and more specifically, in terms of AP mapping in a facility, may provide both 2D and 3D mapping based on a proximity table describing the distances between each pair of APs. As discussed above, MDS may be applied to translate information about pairwise distances among a set of n objects into a configuration of n points mapped into Cartesian space.

The result of solving for AP distance data for a plurality of APs is a full set of locations of the APs. However, while the set of AP locations provides the relationship of the locations all access points, this does not resolve the rotation and inversion of the locations in 3D (or 2D) space, i.e., the set of locations may be oriented in any direction, or may be inverted, while satisfying the AP distance values. In some examples, the rotation and inversion of the set of locations is resolved, such as by server 130, using one or more actual known locations of APs. As noted above, known access points may be referred to as anchor points, and the location of at least three anchor points is generally desired to resolve the mapping of the proximity matrix in 3D space. However, the actual number of anchor points required may depend on the particular circumstances. The location of the anchor points may be determined by any means, including, but not limited to, use of GPS data to provide the needed coordinates. In some examples, the solving of the proximity matrix, including the necessary number of known anchor points, results in generation of a properly oriented set of locations of the access points.

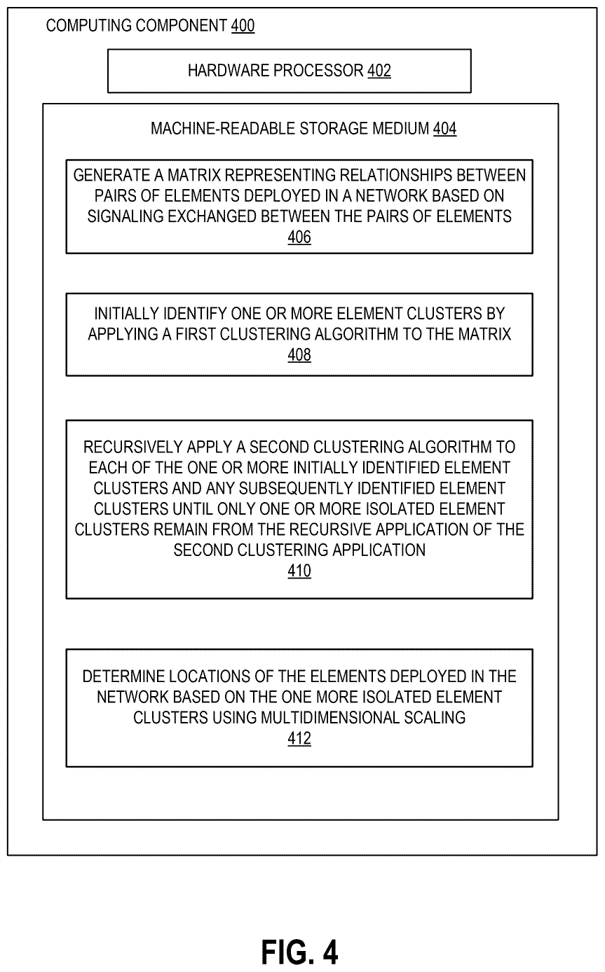

FIG. 4 illustrates a computing component that may be used to implement location determination of APs (or other objects) in a deployment on a per-cluster basis in accordance with various examples of the disclosed technology. Referring now to FIG. 4, computing component 400 may be, for example, a server computer, a controller, or any other similar computing component capable of processing data. In the example implementation of FIG. 4, computing component 400 includes a hardware processor 402, and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-412, to control processes or operations for determining the location of APs/objects in a deployment on a per-cluster basis. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 413 may be a non-transitory storage medium, where the term “non-transitory” does not encompass transitory propagating signals. As described in detail below, machine-readable storage medium 404 may be encoded with executable instructions, for example, instructions 404-412.

Hardware processor 402 may execute instruction 406 to generate a matrix representing relationships between pairs of elements deployed in a network based on signaling exchanged between the pairs of elements. The network elements can be APs, in accordance with examples described herein, but can be other network elements, or simply other objects whose relative distances can be determined. In some examples, the matrix representation can begin as a proximity matrix, where the indices of the matrix reflect the determined distances between the network elements, or simply the relationships between the network elements reflected by exchanged signals. As described above, in order to leverage spectral clustering techniques, the proximity matrix can be converted to an adjacency matrix, where the indices associated with a relative distance, i.e., a non-zero value, that non-zero value can be replaced with the value “1.” Those indices that are not associated with a relative distance or reflect the distance between a network element and itself are assigned a value of “0.” It should be noted that these values are merely used to distinguish between valued indices and non-valued indices, and other representative values may be used to replace non-zero and zero distance values. In this way, the dimensionality of the relative distance data may be reduced to simple, binary values. This can make subsequent processing/analysis more efficient and less resource-intensive, not to mention facilitating the use of spectral clustering techniques. When relying on signals, such as RSSI that reflect signal strength, or simply receipt/non-receipt of signals, such as a Wi-Fi beacon, a proximity matrix is not needed as such information can be binarized “directly” into an adjacency matrix.

Hardware processor 402 may execute instruction 408 to initially identify one or more element clusters by applying a first clustering algorithm to the matrix. In some examples, this first clustering algorithm may be a disjoint set separation function or algorithm. As discussed above, disjoint set separation can determine the existence of clusters from adjacency matrices. However, disjoint set separation results in clusters that are strictly defined, i.e., any link between two network elements, however weak, will result in those two network elements being grouped together in/as a cluster. In scenarios where network elements are only weakly linked, e.g., APs that may hear one other's transmissions, but from a location/mapping perspective, belong to a different geographical area for all intents and purposes, and therefore should be clustered separately to achieve more accurate location determinations.

Accordingly, hardware processor 402 may execute instruction 410 to recursively apply a second clustering algorithm to each of the one or more initially identified element clusters and any subsequently identified element clusters until only one or more isolated element clusters remain from the recursive application of the second clustering application. That is, another clustering algorithm, such as a Louvain's algorithm can be applied to the clusters identified via application of the disjoint set separation algorithm in order to refine the clustering achieved by disjoint set separation algorithm. This is an iterative and recursive process whereby the clusters can be refined (further subdivided into additional clusters) again and again until none of the identified clusters can be further subdivided.

Hardware processor 402 may execute instruction 412 to determine locations of the elements deployed in the network based on the one or more isolated element clusters using multidimensional scaling. As discussed above, examples of the disclosed technology seek to leverage FTM technology, as well as MDS technology in order to determine the location of network elements, such as APs. Providing an optimal characterization of the relative distances between such network elements is facilitated by accurately clustering the network elements. Again, in scenarios where two or more network elements are only weakly linked, location determination is more accurate when the clusters of network elements do not include weakly linked network elements. The two-stage or two-phase iterative and recursive method that leverages multiple clustering algorithms to overcome the limitations of the clustering algorithms when applied in a conventional manner can provide such optimized clustering.

If a customer chooses not to identify which APs belong on a floor or incorrectly identifies some APs, the disclosed iterative, recursive clustering algorithm allows for the correct subdivision of floorplans or other deployment characteristics, which in turn will result in more accurate auto-location results. Moreover, complex deployments that are a function, of, e.g., complex building layouts or installations, can be handled readily by examples of the disclosed technology, thereby increasing the number of conditions under which a auto-location algorithm, e.g., based on FTM and MDS, works correctly. Long-term benefits of tying this data to data from elevation sensors and GPS sensors could allow for improved location accuracy by constraining some APs to be part of the same elevation value.

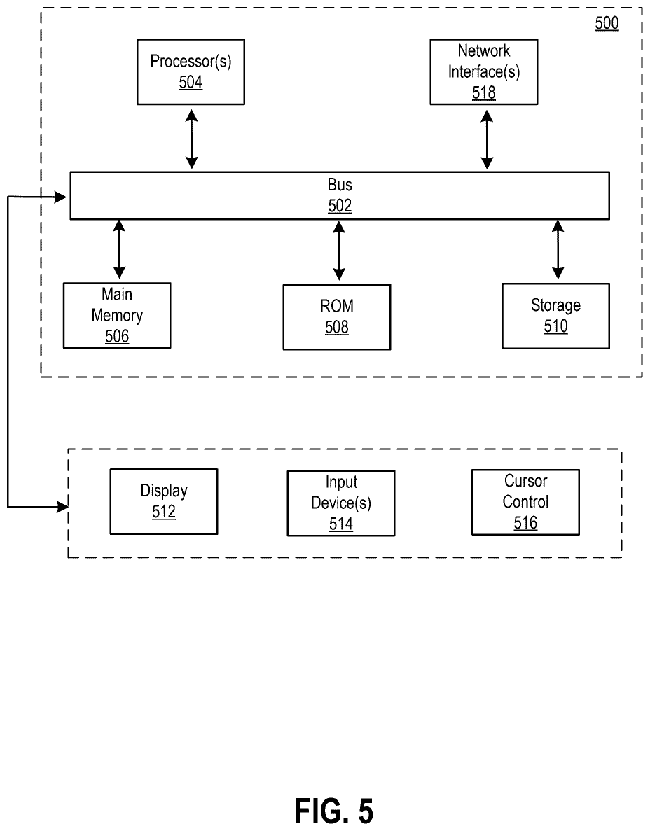

FIG. 5 depicts a block diagram of an example computer system 500 in which various examples of the disclosed technology described herein may be implemented. Various elements or aspects of APs, such as APs A-L of FIGS. 1A and 1B, as well server 130 or controller 120 may be embodied by computer system 500. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some examples, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. It will be appreciated that software components may be callable from other components or from themselves, and/or may be invoked in response to detected events or interrupts.

The computer system 500 may implement the techniques described herein using customized hard-wired logic, one or more ASICs or FPGAs, firmware and/or program logic which in combination with the computer system causes or programs computer system 500 to be a special-purpose machine. According to one example of the disclosed technology, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways.

Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines. It should further be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
generating a matrix representing relationships between pairs of elements deployed in a network based on signaling exchanged between the pairs of elements;
initially identifying one or more element clusters by applying a first clustering algorithm to the matrix;
recursively applying a second clustering algorithm to each of the one or more initially identified element clusters and any subsequently identified element clusters until only one or more isolated element clusters remain from the recursive application of the second clustering algorithm; and
determining locations of the elements deployed in the network based on the one or more isolated element clusters using multidimensional scaling.

2. The method of claim 1, wherein the generating of the matrix comprises generating a proximity matrix whose indices reflect the signaling-based relationships.

3. The method of claim 1, wherein the signaling-based relationships reflect relative distances between the pairs of elements.

4. The method of claim 3, further comprising converting the proximity matrix to an adjacency matrix by distinguishing between indices with a relative distance, and indices without a relative distance.

5. The method of claim 4, wherein the distinguishing comprises replacing indices with a relative distance with a value of 1, and replacing indices without a relative distance with a value of 0.

6. The method of claim 1, wherein the first clustering algorithm comprises a disjoint set separation algorithm that strictly defines clusters to include weakly linked elements.

7. The method of claim 6, wherein the second clustering algorithm comprises a spectral clustering algorithm capable of further subdividing clusters that include weakly linked elements.

8. The method of claim 1, wherein the one or more isolated element clusters are represented as sub-adjacency matrices.

9. The method of claim 8, further comprising converting the sub-adjacency matrices back into proximity matrix form that comprise the relative distances between the elements.

10. The method of claim 1, wherein multidimensional scaling comprises a machine learning technique that translates the relative distances into a configuration of points mapped into Cartesian space.

11. The method of claim 1, wherein the elements comprise access points.

12. A system, comprising:
a processor; and
a memory comprising instructions that when executed, causes the processor to:
communicating instructions to access points (APs) in a deployment to exchange signals to determine relative distances between the APs;
generating a first matrix representation of the relative distances between the APs;
converting the first matrix into a second matrix binary representation of the relative distances between the APs;
determining one or more clusters of APs in the deployment;
refining the determination of the one or more clusters of APs by iteratively and recursively applying a clustering algorithm to subdivide clusters of the one or more clusters that include weakly linked APs into one or more isolated clusters of APs; and
determining locations of the APs based on relative distances reflected in the one or more isolated clusters of APs.

13. The system of claim 1, wherein the instructions that cause the processor to determine the relative distances between the APs comprises instructions that when executed, further cause the processor to calculate round-trip times (RTTs) of the exchanged signals, the calculated RTTs providing a basis for estimating the relative distances between the APs.

14. The system of claim 1, wherein the instructions that cause the processor to generate the first matrix representations comprise instructions that when executed, further cause the processor to input the relative distances between the APs in a proximity matrix, wherein indices of the proximity matrix.

15. The system of claim 14, wherein the second matrix representation comprises an adjacency matrix derived by replacing non-zero relative distance values in the proximity matrix with 1s, and by replacing zero relative distance values in the proximity matrix with 0s.

16. The system of claim 15, wherein the instructions that cause the processor to determine the one or more clusters of APs comprise instructions that when executed, further cause the processor to iterate through indices of the adjacency matrix using a disjoint set separation algorithm to identify the one or more clusters of APs.

17. The system of claim 16, wherein the clustering algorithm comprises Louvain's algorithm.

18. One or more non-transitory computer-readable storage mediums having stored thereon, executable computer program instructions that, when executed by one or more processors, cause the one or more processors to perform operations comprising:
determining relative distances between network elements;
representing the relative distances in a proximity matrix;
converting the proximity matrix into an adjacency matrix;
determining a first set of clusters of network elements from the adjacency matrix by applying a disjoint set separation algorithm;
determining a second set of clusters of network elements by applying a spectral clustering algorithm to clusters of the first set of clusters of network elements, the second set of clusters of network elements comprising only isolated clusters of network elements; and
determining locations of the network elements based on the isolated clusters of network elements.

19. The one or more non-transitory computer-readable storage mediums of claim 18, wherein determining locations of the network elements comprises reverting adjacency matrices representative of the isolated clusters of network elements back to proximity matrices representative of the isolated clusters of network elements.

20. The one or more non-transitory computer-readable storage mediums of claim 19, wherein determining locations of the network elements comprises translating the relative distances reflected in the proximity matrices representative of the isolated clusters of network elements into a configuration of points mapped into Cartesian space.
